(19) United States
(12) Patent Application Publication
(10) Pub. No.: US 2025/0330690 A1
(43) Pub. Date: Oct. 23, 2025

(54) IMAGING DEVICE

(71) Applicant: i-PRO Co., Ltd., Tokyo (JP)

(72) Inventors: Fumihiro ARASE, Tokyo (JP); Yuki ITSUMI, Tokyo (JP); Yuichi HATASE, Tokyo (JP)

(73) Assignee: i-PRO Co., Ltd., Tokyo (JP)

(21) Appl. No.: 19/098,009

(22) Filed: Apr. 2, 2025

(30) Foreign Application Priority Data
Apr. 22, 2024 (JP) 2024-069194

(51) Int. Cl. H04N 23/52; H04N 23/51; H04N 23/56

(52) U.S. Cl. CPC H04N 23/52; H04N 23/51; H04N 23/56

(57) ABSTRACT

An imaging device includes a camera section configured to capture an image of a subject and an illumination section partitioned from and coupled to the camera section and configured to emit illumination light onto the subject. The illumination section includes a housing including a first cover member, a first LED configured to emit the illumination light, and an LED holding member holding the first LED and in surface contact with the first cover member in a state of being rotatable relative to the first cover member.

### CROSS-REFERENCE TO RELATED APPLICATIONS

This application claims the benefit of priority to Japanese Patent Application Number 2024-069194 filed on Apr. 22, 2024. The entire contents of the above-identified application are hereby incorporated by reference.

### TECHNICAL FIELD

The disclosure relates to an imaging device.

### BACKGROUND

JP 6080060 B discloses a surveillance camera in which a camera section and an illumination section have separate housings. The illumination section is provided with a light-emitting diode (LED) as a light source attached thereto. The camera section and the illumination section are coupled to each other and are rotatably supported by a base of the surveillance camera and a support arm connected to the base.

JP 6671060 B describes an imaging device including first and second heat dissipation members that dissipate heat from an LED substrate. The first and second heat dissipation members are attached with the LED substrate interposed therebetween, and dissipate heat generated from the LED substrate.

### SUMMARY

In the surveillance camera set forth in JP 6080060 B described above, the illumination section supplies a significant amount of power to the LED so that a range corresponding to an imaging angle of the camera section can be illuminated in its entirety with one type of LED, that is, so that illumination light reaches a wide range and distant locations. This is because, in the case of an LED having a wide radiation angle, the illumination light is diffused and does not readily reach distant locations. The power is therefore increased, increasing a total light amount so that the illumination light can reach distant locations. As a result, the LED is prone to generate heat. A temperature rise caused by the heat generation of the LED affects an imaging element of the camera section and is one cause of noise generation in a captured image.

Further, when the illumination section having a housing separate from that of the camera section is provided as in the surveillance camera set forth in JP 6080060 B described above, the internal space of the illumination section is limited, making it difficult to newly provide first and second heat dissipation members that dissipate heat from the LED substrate such as in the imaging device set forth in JP 6671060 B described above.

Thus, to suppress power consumption, it is conceivable to perform switching control between an LED having a wide radiation angle and an LED having a narrow radiation angle. An LED having a narrow radiation angle emits illumination light that reaches distant locations but has high directivity. When an LED that emits illumination light having high directivity is used, an adjustment is required, that is, the imaging angle of the camera section needs to be aligned with an illumination direction in advance so that appropriate illumination light can be emitted at the imaging angle of the camera section. On the other hand, in the surveillance camera set forth in JP 6080060 B described above and the imaging device set forth in JP 6671060 B described above, adjustment of the illumination direction is not considered.

An object of the disclosure is to provide an imaging device in which an illumination direction thereof can be adjusted and heat generated by an LED can be efficiently dissipated.

To achieve the object described above, an imaging device according to the disclosure includes a camera section configured to capture an image of a subject and an illumination section partitioned from and coupled to the camera section and configured to emit illumination light onto the subject. The illumination section includes a housing including a first cover member, a first LED configured to emit the illumination light, and an LED holding member holding the first LED and in surface contact with the first cover member in a state of being rotatable relative to the first cover member.

According to the disclosure, it is possible to adjust an illumination direction and efficiently dissipate heat generated by an illumination light source.

### BRIEF DESCRIPTION OF DRAWINGS

FIG. 1 is an outer perspective view of a surveillance camera according to an embodiment.

FIG. 2 is a front view of the surveillance camera.

FIG. 3 is a side view of the surveillance camera.

FIG. 4 is a perspective view of an illumination section.

FIG. 5 is an exploded perspective view of the illumination section.

FIG. 6 is an exploded perspective view of the illumination section excluding an outer cover and a driver board.

FIG. 7 is an exploded perspective view of the illumination section excluding the outer cover and the driver board, as viewed from another direction.

FIG. 8 is a cross-sectional view of a main portion of the illumination section taken along line VIII-VIII in FIG. 4.

FIG. 9 is a cross-sectional view of the main portion of the illumination section taken along line IX-IX in FIG. 4.

FIG. 10 is an explanatory view illustrating an adjustment mechanism.

FIG. 11 is a perspective view of the outer cover as viewed from an inner surface side.

### DESCRIPTION OF EMBODIMENTS

Hereinafter, embodiments of the disclosure will be described with reference to the drawings. These embodiments contribute to “Goal 9: Industry, Innovation, and Infrastructure” of the Sustainable Development Goals (SDGs) proposed by the United Nations by realizing a highly versatile imaging device.

### Overall Configuration of Surveillance Camera

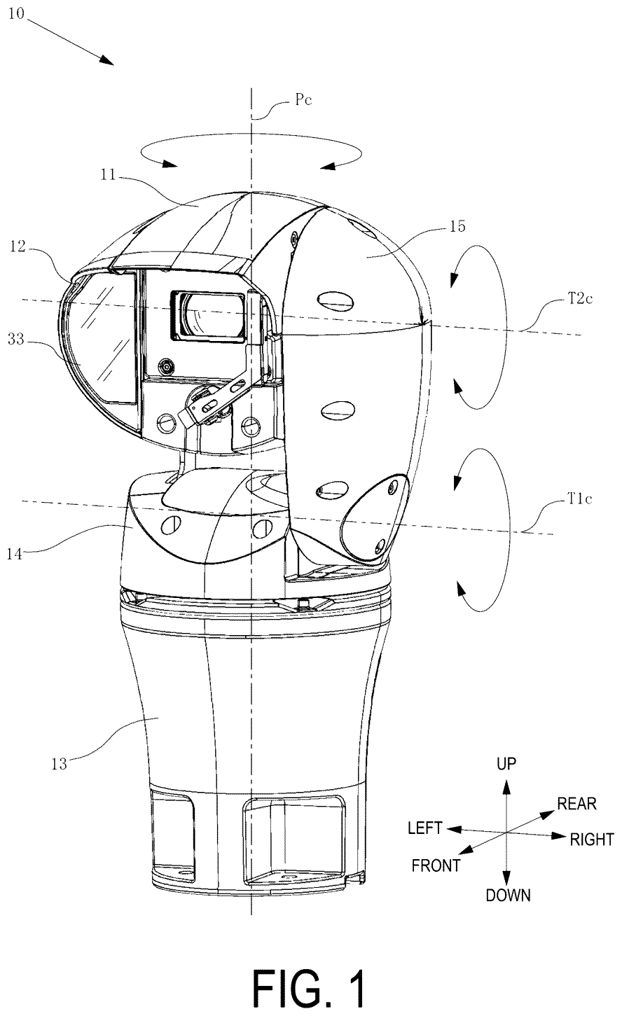

Hereinafter, a surveillance camera that is an aspect of an imaging device according to an embodiment of the disclosure will be described. As illustrated in FIG. 1, a surveillance camera 10 includes a camera section 11, an illumination section 12, a device base 13, a rotation base 14, and a support arm 15.

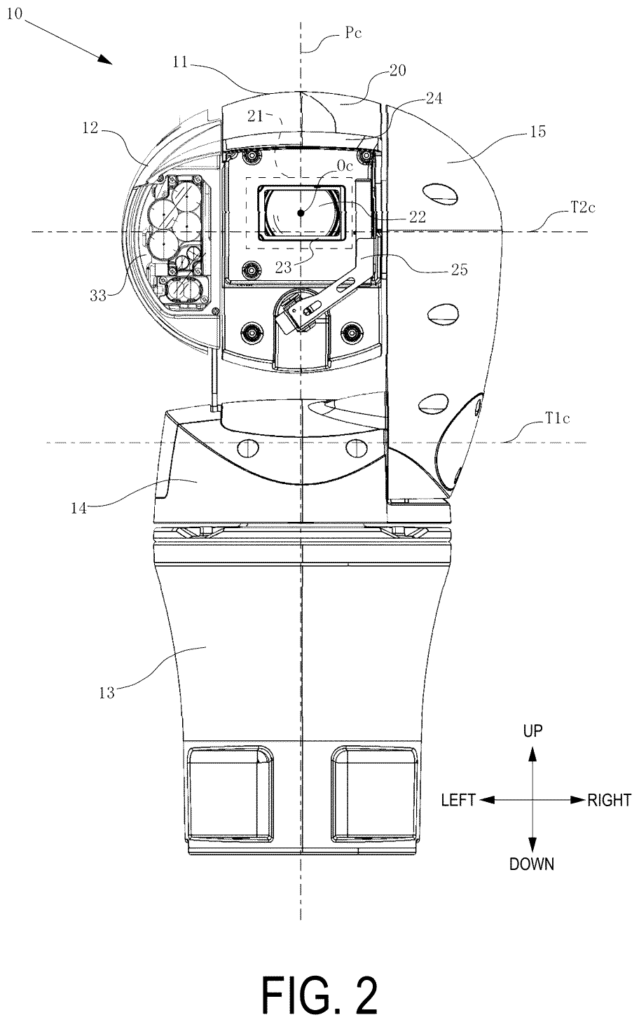

In this specification, under the premise of a posture of the surveillance camera 10 (posture in FIG. 2) in which an optical axis Oc of an imaging unit 21 orthogonally intersects a pan axis Pc and a first tilt axis T1c, an extending direction of the pan axis Pc (up-down direction of the paper surface of FIG. 2) is defined as an up-down direction, an extending direction of the first tilt axis T1c (left-right direction of the paper surface of FIG. 2) is defined as a left-right direction, and a direction orthogonal to the pan axis Pc and the first tilt axis T1c (direction orthogonal to the paper surface of FIG. 2) is defined as a front-rear direction. Further, in the posture of the surveillance camera 10 in FIG. 2, a direction in which the imaging unit 21 captures an image is referred to as “frontward” and a direction opposite thereto is referred to as “rearward.” Furthermore, when viewing the surveillance camera 10 in FIG. 2 from the front (frontward side), upward, downward, leftward, and rightward (that is, upward, downward, leftward, and rightward of the paper surface of FIG. 2) are defined accordingly. However, each direction described above is relative and changes in accordance with the orientation in which the surveillance camera 10 is installed and any change in the posture of the surveillance camera 10.

The device base 13 is formed in a substantially cylindrical shape in which an area of an upper surface (surface on a side facing the rotation base 14) is larger than an area of a lower surface (surface on a lower side in FIG. 1). The device base 13 includes an attachment surface that is the lower surface, and is fixed to a fixed surface, such as a floor, a ceiling, a wall, or a pole, by fasteners such as bolts.

As illustrated in FIG. 2, the rotation base 14 is disposed on the upper surface of the device base 13, and is rotatably supported about the pan axis Pc extending in the up-down direction relative to the device base 13. The pan axis Pc coincides with a central axis of the device base 13.

One end (lower end) of the support arm 15 is attached to the rotation base 14. The other end (upper end) of the support arm 15 is attached to a side surface of the camera section 11 described below. Here, the support arm 15 is rotatable about the pan axis Pc integrally with the rotation base 14. The one end of the support arm 15 is rotatably supported relative to the rotation base 14 about the first tilt axis T1c extending in the left-right direction. The first tilt axis T1c is orthogonal to the pan axis Pc and the optical axis Oc. That is, the support arm 15 is rotatable about the first tilt axis T1c relative to the rotation base 14.

### Configuration of Camera Section 11

The camera section 11 includes a housing 20 having a substantially quadrangular shape in a front view and an elliptical shape in a side view, and the imaging unit 21 incorporated in the housing 20. The imaging unit 21 includes a lens 22 and an imaging element (not illustrated). In the imaging unit 21, a subject image is formed on the imaging element by the lens 22, and the imaging element captures the subject image. The lens 22 is covered with a cover glass 23 provided frontward of the housing 20.

The imaging unit 21 is fixed to the housing 20. This eliminates the need for a mechanism that changes an imaging angle by a physical operation of the imaging unit 21 relative to the housing 20, and makes it possible to save space around the imaging unit 21 and improve the degree of freedom of layout. Further, with the imaging unit 21 being fixed and the degree of freedom of layout being improved, the location where the air from a fan that cools the imaging unit 21 hits can be fixed, facilitating the cooling of the imaging unit 21. As a result, it is possible to readily emit heat from the camera section 11, and restrain the occurrence of noise in a captured image captured by the imaging unit 21.

On the other hand, the focal length and imaging angle of the imaging unit 21 can be varied between a telephoto end, an intermediate distance, and a wide angle end as described below. In particular, when the focal length and the imaging angle of the imaging unit 21 are at the telephoto end or the intermediate distance, the illumination section 12 also emits illumination light for the telephoto end or the intermediate distance in accordance with the imaging unit 21. The illumination light for the telephoto end or the intermediate distance is illumination light having high directivity, and thus an adjustment mechanism 60 described below that adjusts the illumination direction of the illumination light is required in the illumination section 12.

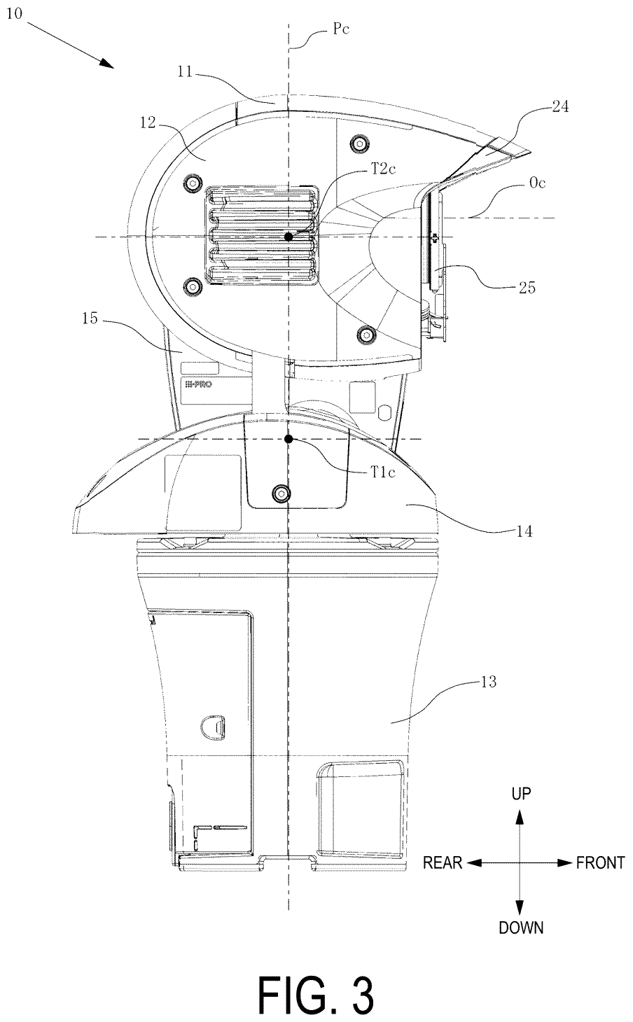

Further, the camera section 11 includes an eave part 24 (refer to FIG. 3) and a wiper 25. The eave part 24 protrudes at a location upward of the cover glass 23 of the housing 20 and frontward of the cover glass 23 of the housing 20, and protects the imaging unit 21 and the cover glass 23 from sunlight and the like. The wiper 25 moves between a location where the wiper 25 covers a front surface of the cover glass 23 and a location where the wiper 25 is retracted away from the cover glass 23, thereby removing dirt from the cover glass 23.

One side surface (right side surface) of the camera section 11 is rotatably supported relative to the other end (upper end) of the support arm 15 about a second tilt axis T2c extending in the left-right direction. The second tilt axis T2c is upward of the first tilt axis T1c and parallel to the first tilt axis T1c. Further, the second tilt axis T2c is orthogonal to the pan axis Pc and the optical axis Oc.

As illustrated in FIG. 3, the second tilt axis T2c passes through the vicinity of a center of gravity of the camera section 11, for example. The camera section 11 is supported by the other end of the support arm 15 at a location spaced apart from the rotation base 14 in the up-down direction. That is, the camera section 11 is tilt-rotatable about the two axes of the first tilt axis T1c and the second tilt axis T2c. As described above, the support arm 15 rotates about the first tilt axis T1c, making it possible to move the camera section 11 in the front-rear direction relative to the rotation base 14. Further, the camera section 11 rotates about the second tilt axis T2c relative to the support arm 15, making it possible to orient the camera section 11 in the up-down direction.

The imaging unit 21 is disposed at a location where the optical axis Oc of the lens 22 is separated from the second tilt axis T2c and in a direction orthogonal to the second tilt axis T2c. The optical axis Oc is disposed at a location on a side opposite to the first tilt axis T1c with the second tilt axis T2c interposed therebetween. The imaging unit 21 captures an image in the direction of the optical axis Oc. The optical axis Oc is an imaginary line passing through a center of the imaging angle of the imaging unit 21.

The imaging unit 21 includes a zoom mechanism, and the focal length and the imaging angle of the lens 22 can be changed. In the present embodiment, the focal length and the imaging angle of the lens 22 can be changed in at least three stages of the telephoto end, the intermediate distance, and the wide angle end. When the imaging angle of the lens 22 is changed, the illumination section 12 performs control for switching light-emitting diodes (LEDs) described below.

### Configuration of Illumination Section 12

The illumination section 12 is provided coupled to the other side surface (left side surface) of the camera section 11. That is, the illumination section 12 is rotatable about the pan axis Pc integrally with the rotation base 14, the support arm 15, and the camera section 11. Further, the illumination section 12 is rotatable about the first tilt axis T1c integrally with the support arm 15 and the camera section 11. Further, the illumination section 12 is rotatable about the second tilt axis T2c integrally with the camera section 11.

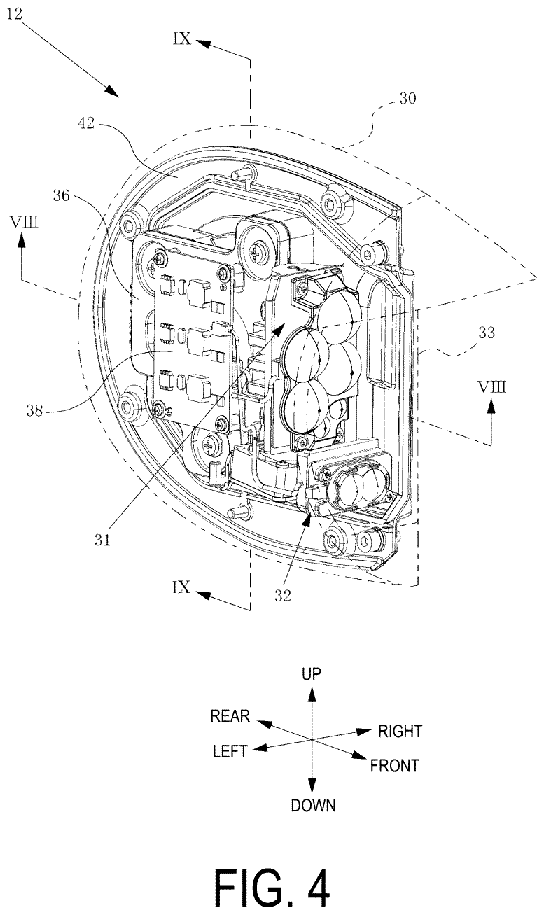

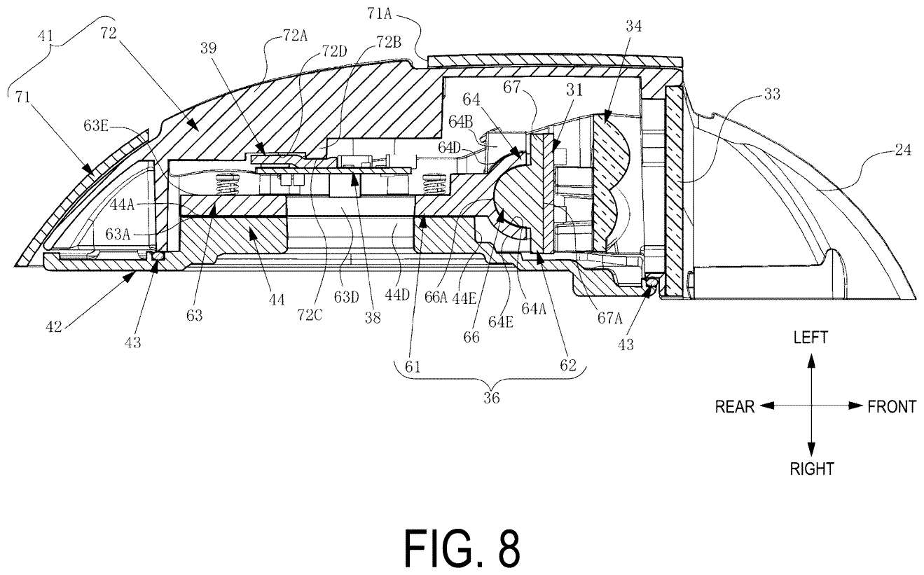

As illustrated in FIG. 4, the illumination section 12 includes a housing 30, a first LED substrate 31, and a second LED substrate 32. The first LED substrate 31 and the second LED substrate 32 are incorporated in the interior of the housing 30 and are covered with a cover glass 33 (refer to FIGS. 2 and 8) provided on a front surface of the housing 30. The housing 30 of the illumination section 12 is a housing different from the housing 20 of the camera section 11. Specifically, a structure is adopted in which an inner cover 42 described below constituting the housing 30 is fixed to the other side surface (left side surface) of the housing 20 of the camera section 11. Therefore, an internal space of the housing 20 accommodating the imaging unit 21 and an internal space of the housing 30 accommodating the illumination section 12 are partitioned from each other. In other words, a space between the imaging unit 21 and the illumination section 12 is defined by the other side surface of the housing 20 and the inner cover 42. Accordingly, even when there are a variety of variations such as a white LED type and an infrared LED type, it is possible to easily accommodate changes in specification.

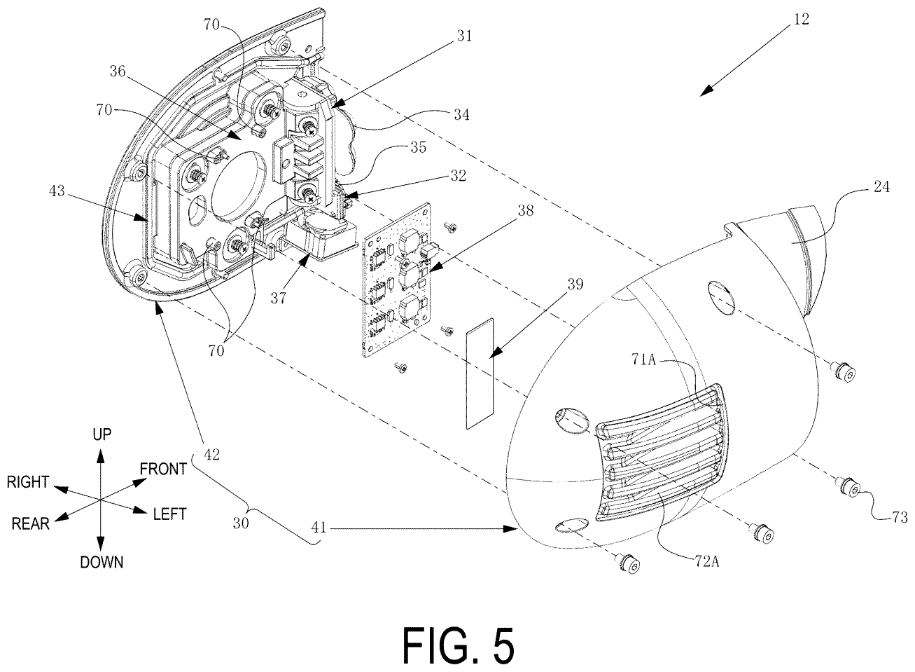

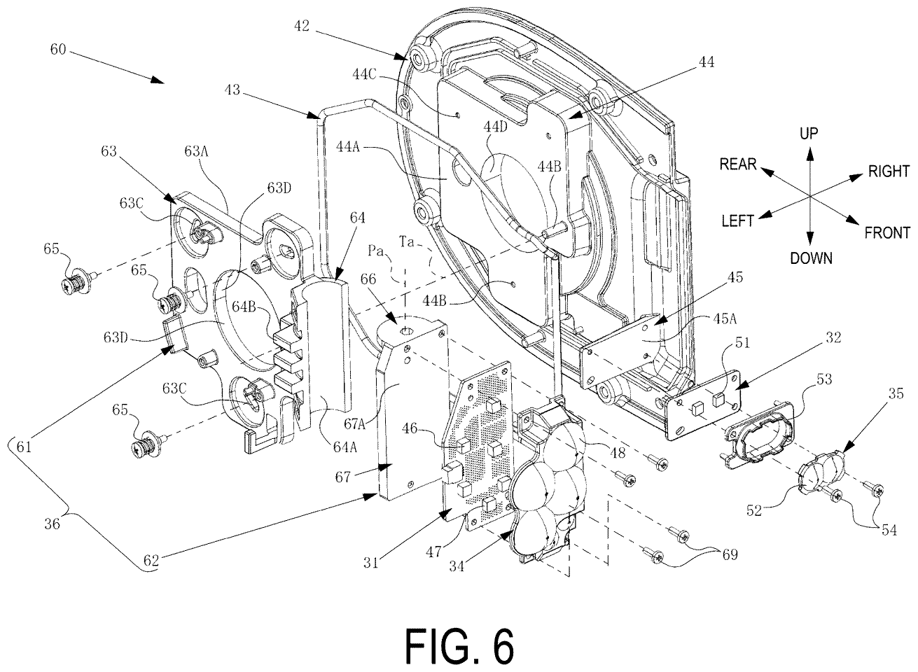

As illustrated in FIG. 5, the illumination section 12 includes, in addition to the housing 30, the first LED substrate 31, and the second LED substrate 32 described above, a first optical member 34, a second optical member 35 (refer to FIG. 6), an LED holding member 36, a cooling fan 37, an LED driver board 38, and a heat dissipation sheet 39.

The housing 30 includes an outer cover 41 (second cover member) and the inner cover 42 (first cover member). A rubber water seal 43 (refer to FIGS. 6, 8, and 9) is provided between the outer cover 41 and the inner cover 42 along an outer periphery of the inner cover 42. An outer surface (right side surface) of the inner cover 42 is disposed at a location facing the other side surface (left side surface) of the camera section 11, an inner surface of the outer cover 41 is disposed facing an inner surface of the inner cover 42, and an outer surface of the outer cover 41 is exposed to the outside. The rubber water seal 43 is interposed between and in close contact with the outer cover 41 and the inner cover 42, thereby preventing water from entering the interior of the housing 30. Note that, in this specification, surfaces of the inner cover 42 facing the camera section 11 and facing the outer cover 41 are referred to as the outer surface and the inner surface, respectively. Further, surfaces of the outer cover 41 facing the inner cover 42 and exposed to the outside are referred to as the inner surface and the outer surface, respectively.

### Configuration of Inner Cover 42

As illustrated in FIG. 6, the inner cover 42 includes a protruding part 44 protruding toward the outer cover 41 side (left side), and a second LED substrate holding part 45 disposed frontward of the protruding part 44. The protruding part 44 is provided on the inner surface side of the inner cover 42. The protruding part 44 has a substantially quadrangular outer shape when viewed from the left side.

The protruding part 44 includes a flat surface 44A, a fitting pin 44B protruding in a direction orthogonal to the flat surface 44A, a plurality of female screw holes 44C, and a through hole 44D. The flat surface 44A is an end surface of the protruding part 44 on a side (left side) facing the outer cover 41, and faces a first holding member 61 described below. The fitting pin 44B is formed in a cylindrical shape protruding from the vicinity of a front end of the flat surface 44A toward the outer cover 41 side (left side), and is fitted into a fitting hole 63B of the first holding member 61 described below. The through hole 44D extends through the inner cover 42 in the left-right direction from the vicinity of a center of the flat surface 44A to the outer surface of the inner cover 42. The through hole 44D allows a cable or the like drawn out from the camera section 11 to pass to the interior of the housing 30. The female screw holes 44C are located in the vicinity of an edge of the flat surface 44A and screws 65 are screwed into the female screw holes 44C.

### Configurations of First LED Substrate 31 and Second LED Substrate 32

A telephoto LED 46 and an intermediate distance LED 47 (first LED) are mounted on the first LED substrate 31. The first optical member 34 is disposed on a front surface of the first LED substrate 31. The first optical member 34 is integrally formed with lenses 48, 49 respectively covering front surfaces of the telephoto LED 46 and the intermediate distance LED 47.

The telephoto LED 46 and the intermediate distance LED 47 are combined with the lens 48 and the lens 49, respectively, making it possible to irradiate the subject with illumination light corresponding to the imaging angle of the imaging unit 21. That is, the lens 48 allows the telephoto LED 46 to emit the illumination light at a narrow radiation angle in accordance with the telephoto end of the imaging unit 21. On the other hand, the lens 49 allows the intermediate distance LED 47 to emit the illumination light at a radiation angle wider than that in the case of the telephoto end in accordance with an intermediate distance of the imaging unit 21.

On the second LED substrate 32, a wide angle LED 51 (second LED) is mounted. The second optical member 35 is disposed on a front surface of the second LED substrate 32. The second optical member 35 is integrally formed with a lens 52 that covers a front surface of the wide angle LED 51. The second optical member 35 is attached to the front surface of the second LED substrate 32 via a holding frame 53.

The wide angle LED 51 is combined with the lens 52, making it possible to emit illumination light corresponding to the imaging angle of the imaging unit 21. That is, the lens 52 allows the wide angle LED 51 to emit the illumination light at a wider radiation angle than that in the case of the intermediate distance, in accordance with a wide angle end of the imaging unit 21.

A second LED substrate holding part 45 protrudes from the inner surface of the inner cover 42 toward the outer cover 41 side (left side), and a front surface thereof facing the cover glass 33 is an attachment surface 45A. The second LED substrate 32 is fixed to the attachment surface 45A of the second LED substrate holding part 45 together with the second optical member 35 and the holding frame 53 by the fastening of screws 54.

### Configuration of Adjustment Mechanism 60

The LED holding member 36 and the inner cover 42 constitute the adjustment mechanism 60. The telephoto LED 46 and the intermediate distance LED 47 have a narrow radiation angle as compared with that of the wide angle LED 51, that is, emit illumination light having high directivity, requiring adjustment of the illumination direction. Note that the wide angle LED 51 that emits illumination light having a wide radiation angle (low directivity) is emitted at a wide angle without adjustment of the illumination direction, and thus the second LED substrate 32 is fixed to the inner cover 42. The LED holding member 36 includes the first holding member 61 and a second holding member 62.

### Configuration of First Holding Member 61

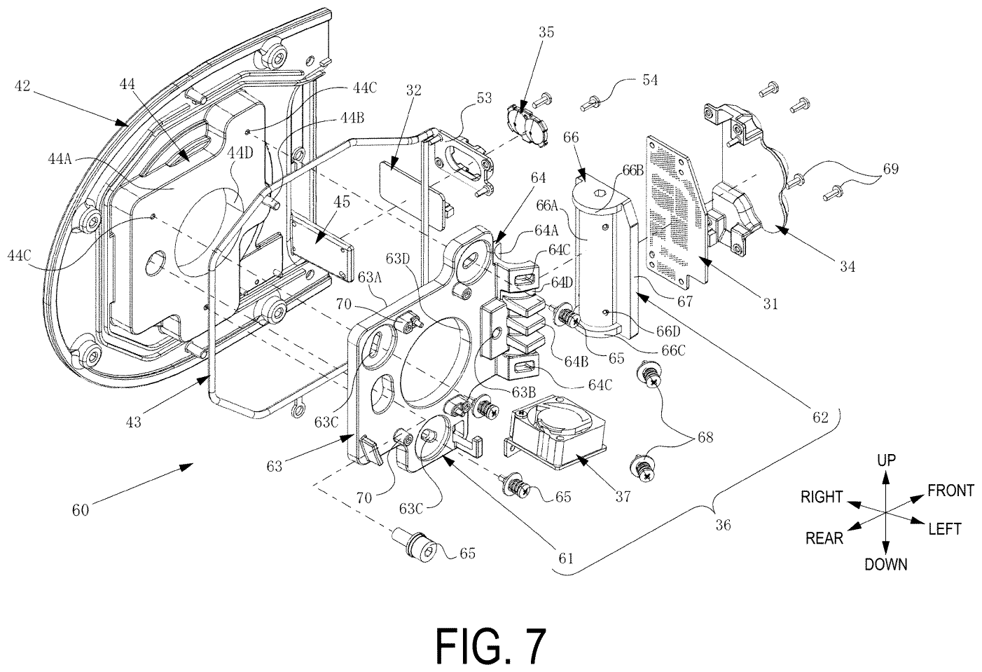

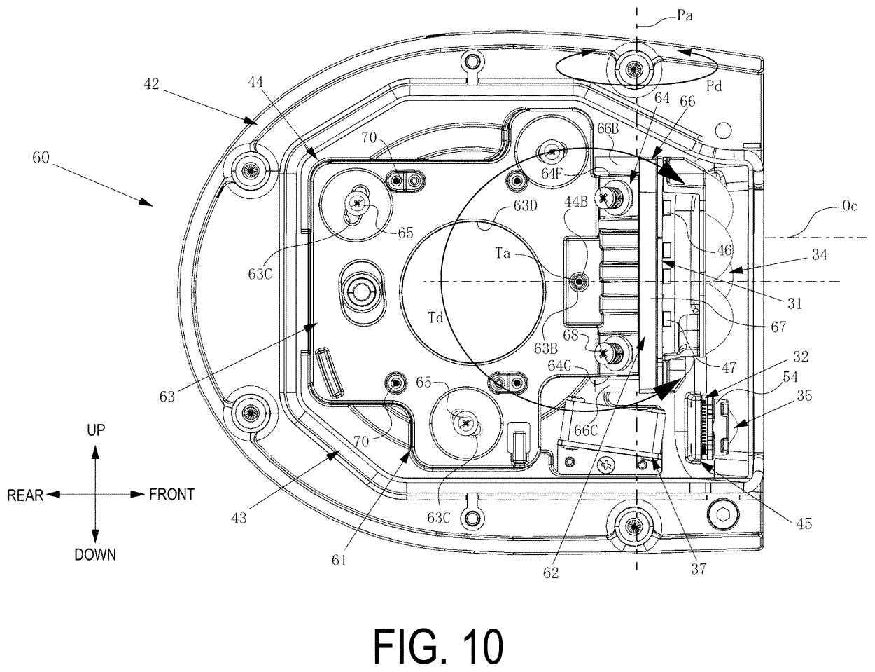

The first holding member 61 is located leftward of the inner cover 42 and includes a tilt adjustment part 63 and a holding part 64. The tilt adjustment part 63 is formed in a flat plate shape having an outer shape similar to that of the protruding part 44. The tilt adjustment part 63 includes a first contact surface 63A, the fitting hole 63B (refer to FIGS. 7 and 10), adjustment long holes 63C, and a through hole 63D. The holding part 64 is formed at one end (front end) of the tilt adjustment part 63. The tilt adjustment part 63 is attached so as to substantially overlap the protruding part 44, positioning the holding part 64 frontward of the protruding part 44. The fitting hole 63B is rotatably fitted to the fitting pin 44B of the inner cover 42.

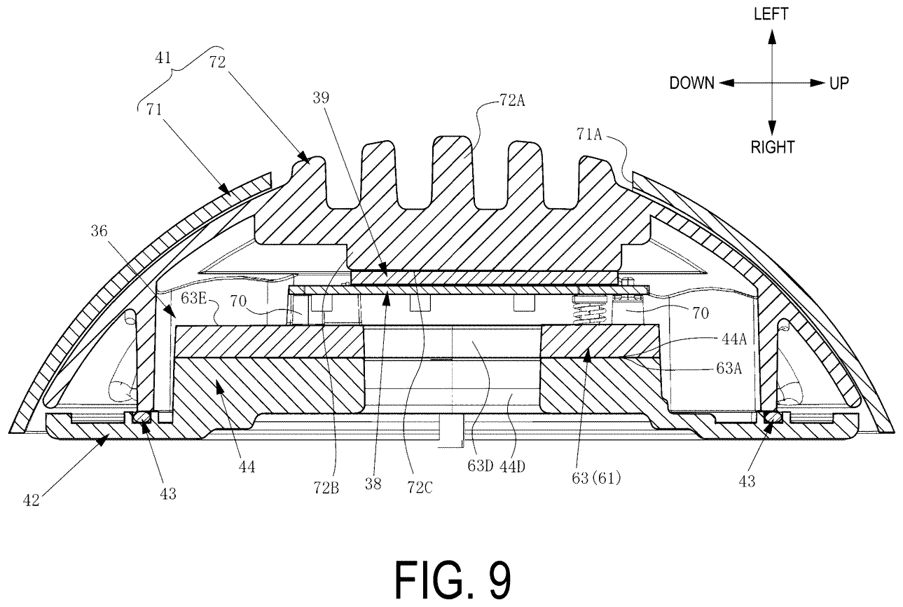

The first holding member 61 is in surface contact with the inner cover 42 in a state of being rotatable about a tilt adjustment axis Ta (refer to FIG. 10) described below relative to the inner cover 42. Specifically, the first contact surface 63A, which is a surface of the tilt adjustment part 63 on a side (right side) facing the flat surface 44A, comes into surface contact with the flat surface 44A (refer to FIGS. 8 and 9). Accordingly, heat is readily transferred from the first holding member 61 to the inner cover 42 through the first contact surface 63A and the flat surface 44A.

The flat surface 44A and the first contact surface 63A are orthogonal to the tilt adjustment axis Ta. The tilt adjustment axis Ta (first adjustment axis) (refer to FIG. 10), which is a central axis of the fitting pin 44B, is disposed intersecting the optical axis Oc of the imaging unit 21 and extending in the left-right direction. Accordingly, the first holding member 61 is rotatable in a tilt direction Td about the tilt adjustment axis Ta (circumferential direction about the tilt adjustment axis Ta; refer to FIG. 10) relative to the inner cover 42. That is, the first holding member 61 is in surface contact with the inner cover 42 in a state of being rotatable about the tilt adjustment axis Ta.

The inner cover 42 of the housing 30 is formed of a metal having high thermal conductivity such as die-cast aluminum or die-cast zinc. Further, the first holding member 61 and the second holding member 62 are also preferably made of a metal having high thermal conductivity such as die-cast aluminum or die-cast zinc. Note that the metal is not limited thereto, and the inner cover 42, the first holding member 61, and the second holding member 62 may be made of a different metal.

The adjustment long holes 63C are a plurality of long holes provided in the vicinity of an edge of the tilt adjustment part 63 and extending in a circumferential direction of the fitting pin 44B (tilt adjustment axis Ta). The screws 65 can be fastened to the female screw holes 44C of the inner cover 42 through the adjustment long holes 63C. Further, it is also possible to temporarily loosen the screws 65 fastened to the female screw holes 44C through the adjustment long holes 63C, rotate the first holding member 61 in the tilt direction Td, and then fasten the screws 65 to the female screw holes 44C again. A cable or the like drawn out from the camera section 11 can pass through the through hole 63D. The cable drawn out from the camera section 11 is connected to the LED driver board 38.

As illustrated in FIG. 7, the holding part 64 includes a recessed part 64A, heat dissipation fins 64B, and adjustment long holes 64C. As illustrated in FIG. 8, the holding part 64 has an arc-shaped cross section as viewed from above and below, and has a shape in which a front surface, an upper surface, and a lower surface are open. The recessed part 64A is an inner circumferential surface having an arc-shaped cross section forming an opening of the holding part 64.

The heat dissipation fins 64B are formed on an outer circumferential surface 64D (refer to FIG. 8) side of the holding part 64. The heat dissipation fins 64B are a plurality of projections protruding in the left-right direction intersecting the outer circumferential surface 64D of the holding part 64. The adjustment long holes 64C are through holes extending through the holding part 64 in a radial direction of the holding part 64 from the outer circumferential surface 64D of the holding part 64 to the recessed part 64A (inner circumferential surface) and extend in a circumferential direction of the holding part 64. The adjustment long holes 64C are located in the vicinity of end portions of the holding part 64, specifically, above and below the heat dissipation fins 64B.

Note that the holding part 64 includes an outer circumferential surface 64E in addition to the outer circumferential surface 64D. The outer circumferential surfaces 64D, 64E are separated from each other with the tilt adjustment part 63 interposed therebetween. For the sake of simplicity, the outer circumferential surface on the side (left side) facing the outer cover 41 is denoted as 64D, and the outer circumferential surface on the side (right side) facing the inner cover 42 is denoted as 64E.

The outer circumferential surface 64E is separated from a front end surface 44E of the protruding part 44 of the inner cover 42 (refer to FIG. 8). This is because the holding part 64 is positioned frontward of the protruding part 44. Accordingly, the heat transferred to the holding part 64 does not affect the protruding part 44. As described above, the heat transfer from the first holding member 61 to the inner cover 42 is facilitated through the first contact surface 63A and the flat surface 44A, whereas heat is not transferred from the outer circumferential surface 64E to the protruding part 44.

### Configuration of Second Holding Member 62

As illustrated in FIG. 7, the second holding member 62 is located frontward of the first holding member 61 and includes a pan adjustment part 66 and a substrate fixing part 67. The pan adjustment part 66 is formed in a columnar shape having a semicircular cross section. The pan adjustment part 66 includes a second contact surface 66A that is an outer circumferential surface having an arc-shaped cross section, flange parts 66B, 66C located at both ends (upper end and lower end) of the second contact surface 66A in a longitudinal direction, and female screw holes 66D.

The substrate fixing part 67 is formed in a substantially rectangular plate shape and is located frontward of the pan adjustment part 66. A front surface of the substrate fixing part 67 facing the cover glass 33 serves as an attachment surface 67A. The attachment surface 67A is a flat surface disposed parallel to a pan adjustment axis Pa described below. The first LED substrate 31 is fixed to the attachment surface 67A of the substrate fixing part 67 together with the first optical member 34 by fastening screws 69. That is, the first LED substrate 31 is located frontward of the first holding member 61 and the second holding member 62. The pan adjustment part 66 is located on a side (rear side) opposite to the attachment surface 67A, that is, the first LED substrate 31, relative to the substrate fixing part 67.

The second contact surface 66A can be fitted into the recessed part 64A. The second contact surface 66A and the recessed part 64A are in surface contact with each other. Specifically, when the pan adjustment part 66 is housed in an interior (on the inner circumferential surface side) of the holding part 64, the second contact surface 66A is in surface contact with the recessed part 64A across the entire circumferential direction (refer to FIG. 8).

The second holding member 62 is in surface contact with the first holding member 61 in a rotatable state relative to the first holding member 61. Specifically, the second holding member 62 is rotatable about the pan adjustment axis Pa (second adjustment axis; refer to FIG. 10) that is a central axis of the second contact surface 66A and the recessed part 64A. Here, the central axis is a central axis when arcs of the second contact surface 66A and the recessed part 64A are extended to form a circle. The pan adjustment axis Pa is disposed intersecting the tilt adjustment axis Ta and the optical axis Oc of the camera section 11 and extending in the up-down direction. Thus, the second holding member 62 is rotatable in a pan direction Pd about the pan adjustment axis Pa (circumferential direction about the pan adjustment axis Pa; refer to FIG. 10). That is, the second holding member 62 is in surface contact with the first holding member 61 in a state of being rotatable about the pan adjustment axis Pa.

The female screw holes 66D are female screw holes open in the radial direction of the pan adjustment part 66 from the second contact surface 66A (outer circumferential surface) of the pan adjustment part 66 toward the central axis. Screws 68 passing through the adjustment long holes 64C can be fastened to the female screw holes 66D. Further, it is also possible to temporarily loosen the screws 68 fastened to the female screw holes 66D through the adjustment long holes 64C, rotate the second holding member 62 in the pan direction Pd, and fasten the screws 68 to the female screw holes 66D again.

The flange parts 66B, 66C radially protrude further than the second contact surface 66A. The flange parts 66B, 66C face both end surfaces 64F, 64G (upper end and lower end) of the holding part 64 (refer to FIG. 10). Thus, the second holding member 62 is restricted from being separated from the holding part 64 in the up-down direction.

The cooling fan 37 is fixed to the inner cover 42 by screw fastening. The cooling fan 37 blows air toward the first LED substrate 31 (refer to FIG. 10). This makes it possible to enhance a heat dissipation effect of the illumination section 12.

As illustrated in FIG. 10, the second LED substrate 32 and the second LED substrate holding part 45 are located frontward of the first LED substrate 31 and the substrate fixing part 67. The wide angle LED 51 that emits illumination light across a wide range can emit the illumination light across a wider range when located on the front side (subject side), and thus preferably the second LED substrate 32 on which the wide angle LED 51 is mounted is disposed on the front side. This makes it possible to create extra space rearward of the second LED substrate 32 and the second LED substrate holding part 45 and extra space downward of the first LED substrate 31 and the substrate fixing part 67.

In the present embodiment, the cooling fan 37 is disposed in the space rearward of the second LED substrate 32 and the second LED substrate holding part 45. This space is also a location downward of the flange part 66C, and air blown by the cooling fan 37 readily strikes the flange part 66C. Thus, the air blown by the cooling fan 37 improves the heat dissipation effect of the pan adjustment part 66 including the flange part 66C, the substrate fixing part 67 integrated with the pan adjustment part 66, and the holding part 64 in contact with the pan adjustment part 66, and improves the heat dissipation effect of the first LED substrate 31 fixed to the substrate fixing part 67.

Further, the first holding member 61 is provided with fixing bosses 70 (refer to FIG. 7) for fixing the LED driver board 38. The fixing bosses 70 are provided at a plurality of locations (four locations in the present embodiment) of the tilt adjustment part 63 and protrude toward the outer cover 41 side (left side). The fixing bosses 70 are disposed at locations in the vicinity of the edge of the tilt adjustment part 63 and different from those of the adjustment long holes 63C. The LED driver board 38 is fixed to the fixing bosses 70 by screw fastening.

### Configuration of LED Driver Board

The LED driver board 38 is connected to the first LED substrate 31 and the second LED substrate 32 via a cable (not illustrated). The LED driver board 38 performs switching control that supplies power to any one of the telephoto LED 46, the intermediate distance LED 47, and the wide angle LED 51 in response to a control signal from the camera section 11. The LED driver board 38 converts power supplied from a power supply (not illustrated) into current values respectively corresponding to the telephoto LED 46, the intermediate distance LED 47, and the wide angle LED 51, and supplies the current values.

The LED driver board 38 converts the current values relative to the power supplied from the power source, and thus the power not supplied to the first LED substrate 31 and the second LED substrate 32 is converted into thermal energy. As a result, the LED driver board 38 serves as a heat source similarly to the first LED substrate 31 and the second LED substrate 32.

As described above, the LED driver board 38 is fixed to the plurality of fixing bosses 70 provided to the tilt adjustment part 63 by screw fastening. Thus, the LED driver board 38 is separated from a surface 63E (left end surface; refer to FIG. 8) of the tilt adjustment part 63 on the outer cover 41 side. In other words, the LED driver board 38 is attached spaced apart from the inner cover 42. Accordingly, the heat generated by the LED driver board 38 is less likely to be transferred to the tilt adjustment part 63 (first holding member 61) side, that is, the inner cover 42 side. Therefore, in the present embodiment, as described below, a configuration is adopted in which the heat generated by the LED driver board 38 is dissipated to the outer cover 41 side.

### Configuration of Outer Cover 41

As illustrated in FIGS. 8 and 9, the outer cover 41 includes a first outer cover 71 and a second outer cover 72. The first outer cover 71 is an exterior cover covering the inner surface of the inner cover 42 and located on the outer side (left side), and has a curved surface shape continuous with the housing 20 of the camera section 11. A through hole 71A is formed in the first outer cover 71. The outer cover 41 is coupled to the inner cover 42 by fastening screws 73 (refer to FIG. 5).

The second outer cover 72 is located on an inner side of the first outer cover 71. The second outer cover 72 includes heat dissipation fins 72A and an extending part 72B. The heat dissipation fins 72A are exposed to the outside through the through hole 71A of the first outer cover 71. Note that the configuration of the second outer cover 72 is not limited thereto and, for example, the heat dissipation fins 72A need not be provided. In the present embodiment, the heat dissipation fins 72A improve the heat dissipation effect of the LED driver board 38.

An inner surface of the second outer cover 72 includes the extending part 72B. The extending part 72B is located on an inner side of the heat dissipation fins 72A and extends toward the inner cover 42 side (right side), that is, toward the LED driver board 38. The heat dissipation sheet 39 is layered on the LED driver board 38 and is located between the extending part 72B and the LED driver board 38. The heat dissipation sheet 39 is a sheet primarily composed of a resin having high flexibility, such as acrylic or silicone, and contains metal material fillers having high thermal conductivity as a filler.

As described above, the LED driver board 38 is screw-fastened to the fixing bosses 70 of the first holding member 61, and is attached spaced apart from the inner cover 42. On the other hand, the outer cover 41 is provided with the extending part 72B, and the heat dissipation sheet 39 is interposed between the extending part 72B and the LED driver board 38 and in close contact with the extending part 72B and the LED driver board 38. Therefore, in the LED driver board 38, heat generated when power is supplied to any one of the telephoto LED 46, the intermediate distance LED 47, and the wide angle LED 51 can be transferred from the extending part 72B to the second outer cover 72 (outer cover 41) via the heat dissipation sheet 39, and further transferred to the heat dissipation fins 72A.

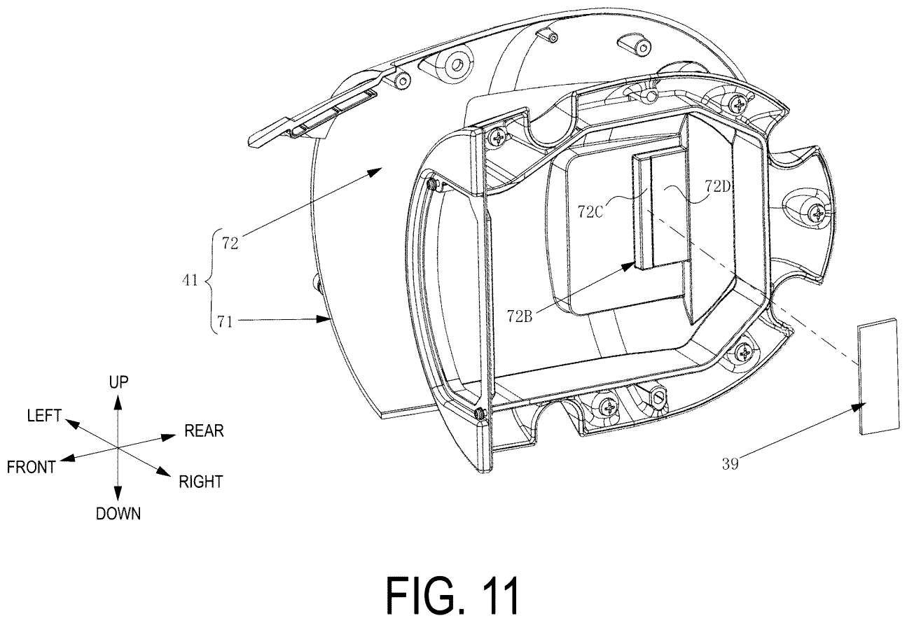

As illustrated in FIGS. 8 and 11, the extending part 72B includes a distal end surface 72C and a stepped surface 72D. The distal end surface 72C is an end surface of the extending part 72B at a location most protruding toward the inner cover 42 side (right side). The stepped surface 72D is a bottom surface of a groove recessed by one step toward the first outer cover 71 side (left side) relative to the distal end surface 72C. The distal end surface 72C is disposed aligned with a portion of the LED driver board 38 where a circuit element is not present, and the stepped surface 72D is disposed aligned with a portion where a circuit element is present. As a result, the extending part 72B does not abut against the heat dissipation sheet 39 and avoids the circuit element at a portion where the stepped surface 72D is located, and the heat dissipation sheet 39 abuts against the LED driver board 38 at a portion where the distal end surface 72C is located. Therefore, the LED driver board 38, the heat dissipation sheet 39, and the extending part 72B are in close contact, making it possible to enhance the heat dissipation effect.

Note that, in the outer cover 41, the second outer cover 72 is made of a metal, and the first outer cover 71 is made of a resin. Note that the material is not limited thereto and both the first outer cover 71 and the second outer cover 72 may be made of a resin.

### Adjustment Process of Illumination Section

Hereinafter, the adjustment of the illumination direction of the telephoto LED 46 and the intermediate distance LED 47 by the adjustment mechanism 60 will be described with reference to FIG. 10. In a state of the first holding member 61, the second holding member 62, the first LED substrate 31, the second LED substrate 32, the first optical member 34, the second optical member 35, and the like being attached to the inner cover 42, the illumination direction of the telephoto LED 46 and the intermediate distance LED 47 is adjusted by the adjustment mechanism 60. This is because, in the telephoto LED 46 and the intermediate distance LED 47 that emit illumination light having a narrow radiation angle (high directivity) as compared with that of the wide angle LED 51, the illumination light cannot be appropriately emitted relative to the imaging angle of the imaging unit 21 unless the illumination direction is adjusted.

Note that, when the illumination direction is adjusted, the LED driver board 38 is electrically connected to the first LED substrate 31 and the second LED substrate 32, but need not be fixed to the fixing bosses 70 of the first holding member 61. Note that, in the present embodiment, presumably the adjustment of the illumination direction by the adjustment mechanism 60 is performed during the assembly process of the surveillance camera 10, but the disclosure is not limited thereto and can be applied to adjustment of the illumination direction after factory shipment, such as during maintenance.

In the adjustment mechanism 60, first, the fastening by the screws 65 is loosened, making it possible to rotate the first holding member 61 in the tilt direction Td relative to the inner cover 42. Then, the illumination direction of the telephoto LED 46 and the intermediate distance LED 47 can be adjusted in the tilt direction Td by the first holding member 61 being rotated in the tilt direction Td relative to the inner cover 42 in a state of the flat surface 44A and the first contact surface 63A being in contact with each other.

Next, the fastening by the screws 68 is loosened, making it possible to rotate the second holding member 62 in the pan direction Pd relative to the first holding member 61. Then, the illumination direction of the telephoto LED 46 and the intermediate distance LED 47 can be adjusted in the pan direction Pd by the second holding member 62 being rotated in the pan direction Pd relative to the first holding member 61 in a state of the recessed part 64A of the holding part 64 and the second contact surface 66A being in contact with each other.

When the illumination direction of the telephoto LED 46 and the intermediate distance LED 47 is adjusted, the camera section 11 and the illumination section 12 currently being adjusted are coupled to each other, and a captured image is acquired by the imaging unit 21 while the subject is irradiated with the illumination light by the illumination section 12, for example. Then, if the captured image is checked and the illumination light reaches a range corresponding to the imaging angle on the whole, it is understood that the adjustment of the illumination direction has been appropriately performed. When a worker confirms that adjustment of the illumination direction by the adjustment mechanism 60 has been appropriately performed, the worker fastens the screws 65, 68 again and fixes the first holding member 61 and the second holding member 62 to the inner cover 42.

### Advantageous Effects of Embodiment

According to the embodiment described above, the LED holding member 36 is in surface contact with the inner cover 42 in a rotatable state, making it possible to adjust the illumination direction of the telephoto LED 46 and the intermediate distance LED 47 and further transfer the heat generated by the telephoto LED 46 and the intermediate distance LED 47 to the inner cover 42 via the LED holding member 36. The inner cover 42 is a component having a large volume and a large area among the components of the illumination section 12, making it possible to sufficiently dissipate the heat generated by the telephoto LED 46 and the intermediate distance LED 47. Further, because the heat generated by the illumination section 12 can be dissipated, it is possible to reduce the effect on the imaging element of the camera section 11 and suppress noise in the captured image.

Further, the LED holding member 36 includes the first holding member 61 in surface contact with the inner cover 42 in a rotatable state about the tilt adjustment axis Ta and the second holding member 62 in surface contact with the first holding member 61 in a rotatable state about the pan adjustment axis Pa, making it possible to adjust the illumination direction of the telephoto LED 46 and the intermediate distance LED 47 in the two directions of the tilt direction Td and the pan direction Pd, more appropriately adjust the illumination direction relative to the imaging angle of the imaging unit 21, and efficiently dissipate the heat generated by the telephoto LED 46 and the intermediate distance LED 47.

Furthermore, the flat surface 44A of the inner cover 42 and the first contact surface 63A of the first holding member 61 are in surface contact with each other, making it possible to readily transfer the heat generated by the first LED substrate 31 (telephoto LED 46 and intermediate distance LED 47) from the first LED substrate 31 to the second holding member 62 and from the second holding member 62 to the first holding member 61, and further transfer the heat to the inner cover 42 through the first contact surface 63A and the flat surface 44A, thereby improving the heat dissipation effect.

Furthermore, the recessed part 64A of the first holding member 61 and the second contact surface 66A of the second holding member 62 are in surface contact with each other, making it possible to readily transfer the heat generated by the first LED substrate 31 (telephoto LED 46 and intermediate distance LED 47) from the second holding member 62 (substrate fixing part 67) to the first holding member 61 through the recessed part 64A and the second contact surface 66A, and readily transfer the heat to the inner cover 42 through the first contact surface 63A and the flat surface 44A as described above. That is, the heat generated by the first LED substrate 31 can be readily transferred to and dissipated from the inner cover 42. This makes it possible to more efficiently dissipate the heat.

Further, the LED driver board 38, which is a heat source similar to the first LED substrate 31 and the second LED substrate 32, includes the outer cover 41 different from the inner cover 42, and the outer cover 41 includes the extending part 72B extending toward the LED driver board 38, making it possible to transfer the heat of the LED driver board 38 from the extending part 72B to the outer cover 41. This makes it possible to readily transfer the heat generated by the LED driver board 38 to the outer cover 41 for dissipation and thus efficiently dissipate the heat of the LED driver board 38 as well.

Further, the LED driver board 38 is fixed only by fastening to the fixing bosses 70. That is, the LED driver board 38 is attached spaced apart from the inner cover 42 and abuts against the distal end surface 72C of the extending part 72B of the outer cover 41 with the heat dissipation sheet 39 interposed therebetween. Therefore, the heat generated by the LED driver board 38 is readily and actively transferred to the outer cover 41. Then, the LED driver board 38 is not in surface contact unlike the adjustment mechanism 60 and is not directly held to the inner cover 42, making it less likely that the heat generated by the LED driver board 38 will be transferred to the inner cover 42. Thus, the heat generated by the LED driver board 38 is readily and actively transferred to the outer cover 41 through the heat dissipation sheet 39 and the extending part 72B, and the heat generated by the first LED substrate 31 (telephoto LED 46 and intermediate distance LED 47) is readily and actively transferred to the inner cover 42 through the second holding member 62 and the first holding member 61. That is, routes through which the heat generated by the LED driver board 38 and the heat generated by the first LED substrate 31 are separate, and thus do not affect each other's heat dissipation effects.

Further, in the wide angle LED 46 that emits illumination light across a wider range than that of the telephoto LED 47 and the intermediate distance LED 51, the second LED substrate 32 is directly fixed to the inner cover 42, making it possible to sufficiently dissipate the generated heat. Further, the wide angle LED 51 has low directivity and does not need to be adjusted in illumination direction, and thus the LED holding member 36 constituting the adjustment mechanism 60 need not be interposed therebetween. Accordingly, the heat generated by the wide angle LED 51 can be efficiently dissipated.

The embodiments described above are examples for describing the disclosure, and are not intended to limit the scope of the disclosure only to these embodiments. Those skilled in the art can make appropriate changes without departing from the spirit of the disclosure.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. An imaging device comprising:
a camera section configured to capture an image of a subject; and
an illumination section partitioned from and coupled to the camera section and configured to emit illumination light onto the subject, wherein
the illumination section includes
a housing including a first cover member,
a first LED configured to emit the illumination light, and
an LED holding member holding the first LED and in surface contact with the first cover member in a state of being rotatable relative to the first cover member.

2. The imaging device according to claim 1, wherein
the LED holding member includes
a first holding member in surface contact with the first cover member in a state of being rotatable about a first adjustment axis,
a second holding member to which the first LED is fixed, the second holding member being in surface contact with the first holding member in a state of being rotatable about a second adjustment axis intersecting the first adjustment axis.

3. The imaging device according to claim 2, wherein
the first cover member includes a flat surface orthogonal to the first adjustment axis,
the first holding member includes a first contact surface orthogonal to the first adjustment axis, the first contact surface being in surface contact with the flat surface, and
the first holding member rotates about the first adjustment axis relative to the first cover member in a state of the flat surface and the first contact surface being in surface contact with each other.

4. The imaging device according to claim 2, wherein
the first holding member includes a recessed part being an inner circumferential surface having an arc-shaped cross section,
the second holding member includes a second contact surface being an outer circumferential surface having an arc-shaped cross section, the second contact surface being in surface contact with the recessed part, and
the second holding member rotates about the second adjustment axis relative to the first holding member in a state of the recessed part and the second contact surface being in surface contact with each other.

5. The imaging device according to claim 1, wherein
the illumination section includes
an LED driver board configured to supply power to the first LED, and
a second cover member included in the housing and different from the first cover member, and
the second cover member includes an extending part extending toward the LED driver board.

6. The imaging device according to claim 5, wherein
the second cover member covers an inner surface of the first cover member,
the LED driver board is attached spaced apart from the first cover member, and
a heat dissipation sheet layered on the LED driver board abuts against an end surface of the extending part.

7. The imaging device according to claim 1, comprising
a second LED configured to emit illumination light across a range wider than a range of the first LED, wherein
the second LED is fixed to the first cover member.

8. The imaging device according to claim 1, wherein
the illumination section is fixed to the first cover member and provided with a fan configured to cool the first LED.
